(19) United States
(12) Patent Application Publication
(10) Pub. No.: US 2025/0237854 A1
(43) Pub. Date: Jul. 24, 2025

(54) VARIABLE MAGNIFICATION OPTICAL SYSTEM, OPTICAL APPARATUS, AND VARIABLE MAGNIFICATION OPTICAL SYSTEM MANUFACTURING METHOD

(71) Applicant: NIKON CORPORATION, Shinagawa-ku, Tokyo (JP)

(72) Inventors: Takuro ONO, Okegawa-shi (JP); Hideyuki TACHI, yokohama-shi (JP)

(21) Appl. No.: 18/881,851

(22) PCT Filed: Jul. 10, 2023
(86) PCT No.: PCT/JP2023/025401

§ 371 Date: Jan. 7, 2025

(30) Foreign Application Priority Data
Aug. 10, 2022 (JP) 2022-127959

(51) Int. Cl. G02B 13/00; G02B 7/02; G02B 15/14

(52) U.S. Cl. CPC G02B 13/009; G02B 7/025; G02B 13/0045; G02B 13/006; G02B 15/1461

(57) ABSTRACT

A zoom optical system (ZL) consists of, in order from an object side on an optical axis: an object lens group having positive refractive power (GA); an intermediate group having positive refractive power (GM); and a rear group (GR), where the intermediate group (GM) comprises at least one lens group, where the rear group (GR) comprises, in order from the object side on the optical axis: a first succeeding lens group having negative refractive power (GR1); a second succeeding lens group having positive refractive power (GR2); and a third succeeding lens group having negative refractive power (GR3), where a distance between each adjacent lens group varies upon zooming, where the second succeeding lens group (GR2) moves on the optical axis upon focusing, and where a following conditional expression is satisfied:

$$1. 05 < f 1 / TLw < 2.00$$

where f1 is a focal length of the object lens group (GA), and TLw is an entire length of the zoom optical system (ZL) in a wide-angle end state.

### TECHNICAL FIELD

The present invention relates to a zoom optical system, an optical apparatus, and a zoom optical system manufacturing method.

### TECHNICAL BACKGROUND

Zoom optical systems have been previously proposed that are suitable for photographic cameras, electronic still cameras, video cameras, and the like (for example, see Patent Document 1). Such zoom optical systems are difficult to miniaturize while obtaining bright and good optical performance.

### PRIOR ARTS LIST

### Patent Document

Patent Document 1: Japanese Patent Laid-Open Application No. 2021-43375

### SUMMARY OF THE INVENTION

A zoom optical system of a first aspect consists of, in order from an object side on an optical axis: an object lens group having positive refractive power; an intermediate group having positive refractive power; and a rear group, where the intermediate group comprises at least one lens group, where the rear group comprises, in order from the object side on the optical axis: a first succeeding lens group having negative refractive power; a second succeeding lens group having positive refractive power; and a third succeeding lens group having negative refractive power, where a distance between each adjacent lens group varies upon zooming, where the second succeeding lens group moves on the optical axis upon focusing, and where a following conditional expression is satisfied:

$$1. 05 < f 1 / TLw < 2.00$$

where f1 is a focal length of the object lens group, and TLw is an entire length of the zoom optical system in a wide-angle end state.

A zoom optical system of a second aspect consists of, in order from an object side on an optical axis: an object lens group having positive refractive power; an intermediate group having positive refractive power; and a rear group, where the intermediate group comprises at least one lens group, where the rear group comprises, in order from the object side on the optical axis: a first succeeding lens group having negative refractive power; a second succeeding lens group having positive refractive power; and a third succeeding lens group having negative refractive power, where a distance between each adjacent lens group varies and at least one lens group in the intermediate group is fixed relative to an image plane upon zooming, and where a following conditional expression is satisfied:

$$2. < f 1 / fMw < 7.00$$

where f1 is a focal length of the object lens group, and fMw is a combined focal length of the intermediate group in a wide-angle end state.

An optical apparatus of a third aspect comprises either of the zoom optical systems according to the above.

A zoom optical system manufacturing method of a fourth aspect is for manufacturing a zoom optical system consisting of, in order from an object side on an optical axis: an object lens group having positive refractive power; an intermediate group having positive refractive power; and a rear group, and the method comprises steps of disposing each lens in a lens barrel in such a way that the intermediate group comprises at least one lens group, the rear group comprises, in order from the object side on the optical axis: a first succeeding lens group having negative refractive power; a second succeeding lens group having positive refractive power; and a third succeeding lens group having negative refractive power, a distance between each adjacent lens group varies upon zooming, the second succeeding lens group moves on the optical axis upon focusing, and a following conditional expression is satisfied:

$$1. 05 < f 1 / TLw < 2.00$$

where f1 is a focal length of the object lens group, and TLw is an entire length of the zoom optical system in a wide-angle end state.

A zoom optical system manufacturing method of a fifth aspect is for manufacturing a zoom optical system consisting of, in order from an object side on an optical axis: an object lens group having positive refractive power; an intermediate group having positive refractive power; and a rear group, and the method comprises steps of disposing each lens in a lens barrel in such a way that the intermediate group comprises at least one lens group, the rear group comprises, in order from the object side on the optical axis: a first succeeding lens group having negative refractive power; a second succeeding lens group having positive refractive power; and a third succeeding lens group having negative refractive power, a distance between each adjacent lens group varies and at least one lens group in the intermediate group is fixed relative to an image plane upon zooming, and a following conditional expression is satisfied:

$$2. 00 < f 1 / fMw < 7.00$$

where f1 is a focal length of the object lens group, and fMw is a combined focal length of the intermediate group in a wide-angle end state.

### BRIEF DESCRIPTION OF THE DRAWINGS

FIG. 1 shows a lens configuration of a zoom optical system of a first example;

FIGS. 2 (A) and 2 (B) present graphs showing various aberrations of the zoom optical system of the first example upon focusing on infinity in the wide-angle end state and the telephoto end state, respectively;

FIG. 3 shows a lens configuration of a zoom optical system of a second example;

FIGS. 4 (A) and 4 (B) present graphs showing various aberrations of the zoom optical system of the second example upon focusing on infinity in the wide-angle end state and the telephoto end state, respectively;

FIG. 5 shows a lens configuration of a zoom optical system of a third example;

FIGS. 6 (A) and 6 (B) present graphs showing various aberrations of the zoom optical system of the third example upon focusing on infinity in the wide-angle end state and the telephoto end state, respectively;

FIG. 7 shows a configuration of a camera comprising a zoom optical system of each embodiment;

FIG. 8 is a flowchart showing a method for manufacturing a zoom optical system of a first embodiment; and

FIG. 9 is a flowchart showing a method for manufacturing a zoom optical system of a second embodiment.

### DESCRIPTION OF THE EMBODIMENTS

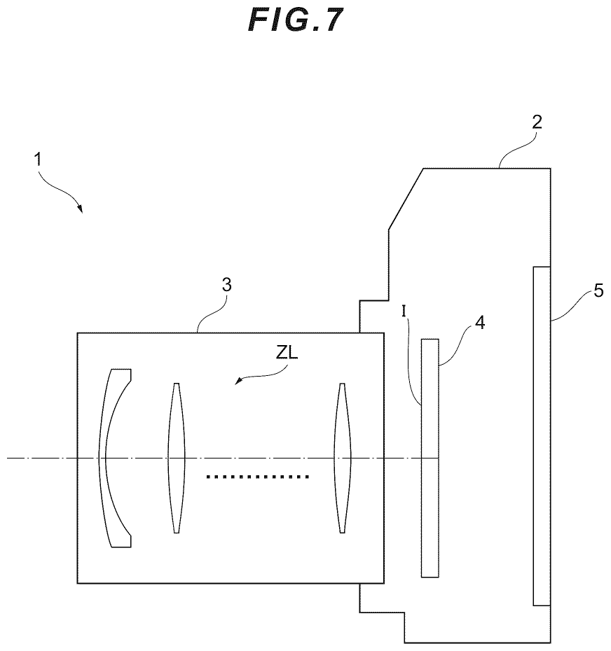

Now, preferred embodiments of the present invention will be described. First, a camera comprising a zoom optical system of each embodiment (an optical apparatus) will be described with reference to FIG. 7. As shown in FIG. 7, this camera 1 comprises a body 2, and a taking lens 3 mounted on the body 2. The body 2 comprises an imaging device 4, a body controller (not shown) for controlling the operation of the digital camera, and an LCD screen 5. The taking lens 3 comprises a zoom optical system ZL consisting of a plurality of lens groups, and a lens position control mechanism (not shown) for controlling the position of each lens group. The lens position control mechanism comprises a sensor for detecting the positions of lens groups, a motor for moving lens groups back and forth on the optical axis, a control circuit for driving the motor, and the like.

Light from a subject is collected by the zoom optical system ZL of the taking lens 3, and reaches an image plane I of the imaging device 4. Upon reaching the image plane I, the light from the subject is photoelectrically converted by the imaging device 4, and is recorded as digital image data on a memory not shown. The digital image data recorded on the memory can be displayed on the LCD screen 5 according to a user's operation. Note that this camera may be a mirrorless camera, or a camera of a single-lens reflex type having a quick return mirror. In addition, the zoom optical system ZL shown in FIG. 7 is a schematically-shown zoom optical system to be provided in the taking lens 3, and the lens configuration of the zoom optical system ZL is not limited to this configuration.

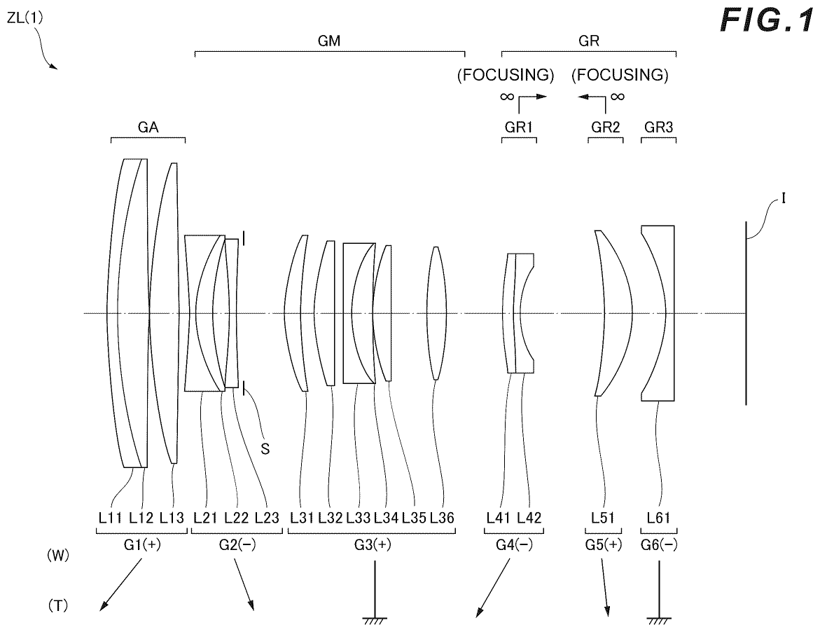

A zoom optical system of a first embodiment will be described next. As shown in FIG. 1, a zoom optical system ZL (1) as an example of the zoom optical system (zoom lens) ZL of the first embodiment consists of, in order from an object side on an optical axis: an object lens group having positive refractive power, GA; an intermediate group having positive refractive power, GM; and a rear group GR. The intermediate group GM comprises at least one lens group. The rear group GR comprises, in order from the object side on the optical axis: a first succeeding lens group having negative refractive power, GR1; a second succeeding lens group having positive refractive power, GR2; and a third succeeding lens group having negative refractive power, GR3. The distance between each adjacent lens group varies upon zooming. The second succeeding lens group GR2 moves on the optical axis upon focusing.

In the above-described configuration, the zoom optical system ZL of the first embodiment satisfies the following conditional expression (1):

$$1. 05 < f 1 / TLw < 2. \qquad ( 1 )$$

where f1 is the focal length of the object lens group GA, and TLw is the entire length of the zoom optical system ZL in the wide-angle end state.

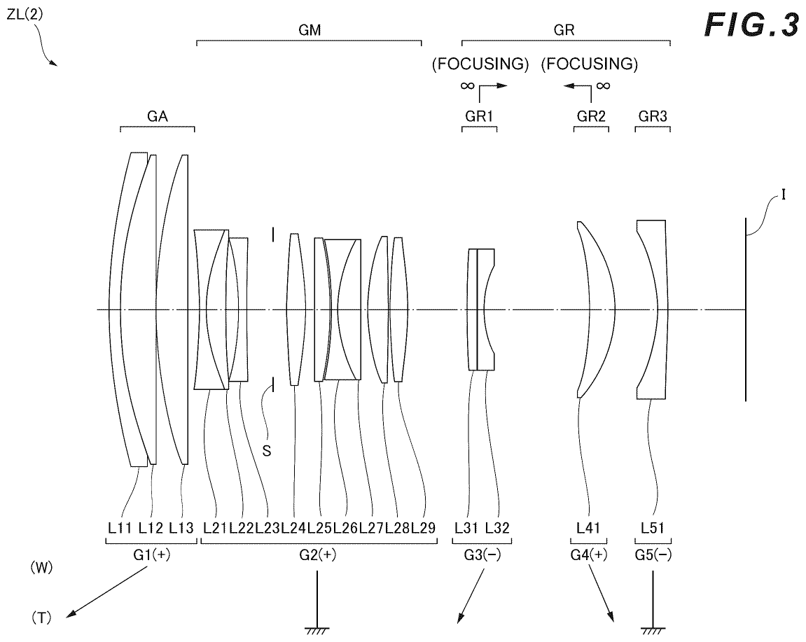

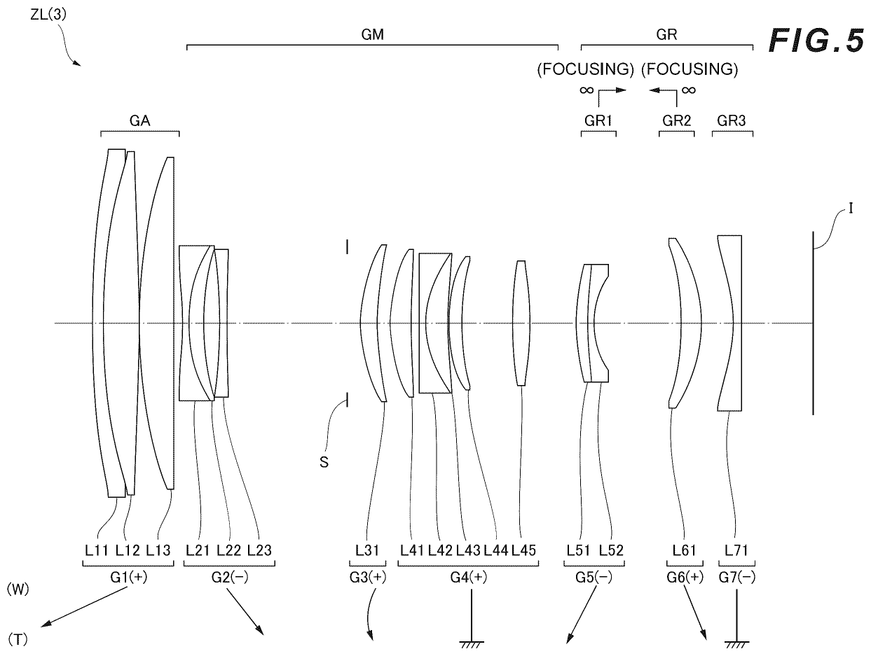

The first embodiment allows for obtaining a zoom optical system that is small yet with bright and good optical performance and an optical apparatus comprising this zoom optical system. The zoom optical system ZL of the first embodiment may be a zoom optical system ZL (2) shown in FIG. 3, or a zoom optical system ZL (3) shown in FIG. 5.

The conditional expression (1) defines an appropriate relationship between the focal length of the object lens group GA and the entire length of the zoom optical system ZL in the wide-angle end state. Satisfying the conditional expression (1) allows for correcting the spherical aberration well.

If the corresponding value of the conditional expression (1) exceeds the upper limit, the refractive power of the object lens group GA weakens and it becomes difficult to miniaturize the zoom optical system ZL while correcting the spherical aberration. Setting the upper limit of the conditional expression (1) to 1.90, 1.80, 1.70, 1.60, or even 1.50 allows for ensuring the advantage of the embodiment more firmly.

If the corresponding value of the conditional expression (1) falls below the lower limit, the refractive power of the object lens group GA strengthens and it becomes difficult to correct the spherical aberration that occurs in the telephoto end state. Setting the lower limit of the conditional expression (1) to 1.10, 1.15, 1.20, 1.25, or even 1.30 allows for ensuring the advantage of the embodiment more firmly.

A zoom optical system of a second embodiment will be described next. The zoom optical system ZL of the second embodiment has the same configuration as the zoom optical system ZL of the first embodiment, and therefore will be described with the same symbols as the first embodiment. As shown in FIG. 1, a zoom optical system ZL (1) as an example of the zoom optical system (zoom lens) ZL of the second embodiment consists of, in order from an object side on an optical axis: an object lens group having positive refractive power, GA; an intermediate group having positive refractive power, GM; and a rear group GR. The intermediate group GM comprises at least one lens group. The rear group GR comprises, in order from the object side on the optical axis: a first succeeding lens group having negative refractive power, GR1; a second succeeding lens group having positive refractive power, GR2; and a third succeeding lens group having negative refractive power, GR3. The distance between each adjacent lens group varies and at least one lens group in the intermediate group GM is fixed relative to an image plane I upon zooming.

In the above-described configuration, the zoom optical system ZL of the second embodiment satisfies the following conditional expression (2):

$$2. < f 1 / fMw < 7. \qquad ( 2 )$$

where f1 is the focal length of the object lens group GA, and fMw is the combined focal length of the intermediate group GM in the wide-angle end state.

The second embodiment allows for obtaining a zoom optical system that is small yet with bright and good optical performance and an optical apparatus comprising this zoom optical system. The zoom optical system ZL of the second embodiment may be the zoom optical system ZL (2) shown in FIG. 3, or the zoom optical system ZL (3) shown in FIG. 5.

The conditional expression (2) defines an appropriate relationship between the focal length of the object lens group GA and the combined focal length of the intermediate group GM in the wide-angle end state. Satisfying the conditional expression (2) allows for correcting the coma aberration and the curvature of field well.

If the corresponding value of the conditional expression (2) exceeds the upper limit, the refractive power of the intermediate group GM in the wide-angle end state strengthens and it becomes difficult to suppress the fluctuation in coma aberration and curvature of field upon zooming. Setting the upper limit of the conditional expression (2) to 6.75, 6.50, 6.25, 6.00, 5.75, or even 5.50 allows for ensuring the advantage of the embodiment more firmly.

If the corresponding value of the conditional expression (2) falls below the lower limit, the refractive power of the intermediate group GM in the wide-angle end state weakens and it becomes difficult to miniaturize the zoom optical system ZL while correcting the coma aberration and the curvature of field. Setting the lower limit of the conditional expression (2) to 2.25, 2.50, 2.75, 3.00, 3.25, or even 3.50 allows for ensuring the advantage of the embodiment more firmly.

In the zoom optical system ZL of the second embodiment, the second succeeding lens group GR2 preferably moves on the optical axis upon focusing.

The zoom optical system ZL of the first and second embodiments preferably satisfies the following conditional expression (3):

$$1.5 < f 1 / ( - fn 1 ) < 6. \qquad ( 3 )$$

where fn1 is the focal length of a lens group disposed closest to the object side among lens groups in the zoom optical system ZL that have negative refractive power.

The conditional expression (3) defines an appropriate relationship between the focal length of the object lens group GA and the focal length of a lens group disposed closest to the object side among lens groups in the zoom optical system ZL that have negative refractive power. Satisfying the conditional expression (3) allows for correcting the spherical aberration well.

If the corresponding value of the conditional expression (3) exceeds the upper limit, the refractive power of the object lens group GA weakens and it becomes difficult to miniaturize the zoom optical system ZL while correcting the spherical aberration. Setting the upper limit of the conditional expression (3) to 5.50, 5.00, 4.50, 4.00, or even 3.50 allows for ensuring the advantage of each embodiment more firmly.

If the corresponding value of the conditional expression (3) falls below the lower limit, the refractive power of the object lens group GA strengthens and it becomes difficult to correct the spherical aberration that occurs in the telephoto end state. Setting the lower limit of the conditional expression (3) to 1.75, 2.00, 2.25, or even 2.50 allows for ensuring the advantage of each embodiment more firmly.

The zoom optical system ZL of the first and second embodiments preferably satisfies the following conditional expression (4):

$$0.5 < ( - fR 3 ) / ft < 1.00 \qquad ( 4 )$$

where fR3 is the focal length of the third succeeding lens group GR3, and ft is the focal length of the zoom optical system ZL in the telephoto end state.

The conditional expression (4) defines an appropriate relationship between the focal length of the third succeeding lens group GR3 and the focal length of the zoom optical system ZL in the telephoto end state. Satisfying the conditional expression (4) allows for miniaturization while correcting the distortion well.

If the corresponding value of the conditional expression (4) exceeds the upper limit, the refractive power of the third succeeding lens group GR3 weakens and it becomes difficult to miniaturize the zoom optical system ZL while correcting the distortion. Setting the upper limit of the conditional expression (4) to 0.80, 0.60, 0.50, or even 0.40 allows for ensuring the advantage of each embodiment more firmly.

If the corresponding value of the conditional expression (4) falls below the lower limit, the refractive power of the third succeeding lens group GR3 strengthens and it becomes difficult to suppress the fluctuation in distortion upon zooming. Setting the lower limit of the conditional expression (4) to 0.10, 0.15, 0.20, or even 0.25 allows for ensuring the advantage of each embodiment more firmly.

The zoom optical system ZL of the first and second embodiments preferably satisfies the following conditional expression (5):

$$0. < ( - fR 3 ) / fw < 2.00 \qquad ( 5 )$$

where fR3 is the focal length of the third succeeding lens group GR3, and fw is the focal length of the zoom optical system ZL in the wide-angle end state.

The conditional expression (5) defines an appropriate relationship between the focal length of the third succeeding lens group GR3 and the focal length of the zoom optical system ZL in the wide-angle end state. Satisfying the conditional expression (5) allows for miniaturization while correcting the distortion well.

If the corresponding value of the conditional expression (5) exceeds the upper limit, the refractive power of the third succeeding lens group GR3 weakens and it becomes difficult to miniaturize the zoom optical system ZL while correcting the distortion. Setting the upper limit of the conditional expression (5) to 1.75, 1.50, 1.25, or even 1.00 allows for ensuring the advantage of each embodiment more firmly.

If the corresponding value of the conditional expression (5) falls below the lower limit, the refractive power of the third succeeding lens group GR3 strengthens and it becomes difficult to suppress the fluctuation in distortion upon zooming. Setting the lower limit of the conditional expression (5) to 0.20, 0.40, 0.50, or even 0.60 allows for ensuring the advantage of each embodiment more firmly.

The zoom optical system ZL of the first and second embodiments preferably satisfies the following conditional expression (6):

$$0.15 < ( TLt - TLw ) / TLw < 1. \qquad ( 6 )$$

where TLt is the entire length of the zoom optical system ZL in the telephoto end state, and TLw is the entire length of the zoom optical system ZL in the wide-angle end state.

The conditional expression (6) defines an appropriate relationship between the entire length of the zoom optical system ZL in the telephoto end state and the entire length of the zoom optical system ZL in the wide-angle end state. Satisfying the conditional expression (6) allows for correcting the spherical aberration well.

If the corresponding value of the conditional expression (6) exceeds the upper limit, the refractive power of the object lens group GA weakens and it becomes difficult to miniaturize the zoom optical system ZL while correcting the spherical aberration. Setting the upper limit of the conditional expression (6) to 0.90, 0.80, 0.70, or even 0.60 allows for ensuring the advantage of each embodiment more firmly.

If the corresponding value of the conditional expression (6) falls below the lower limit, the refractive power of the object lens group GA strengthens and it becomes difficult to correct the spherical aberration that occurs in the telephoto end state. Setting the lower limit of the conditional expression (6) to 0.20, 0.25, 0.30 or even 0.35 allows for ensuring the advantage of each embodiment more firmly.

The zoom optical system ZL of the first and second embodiments preferably satisfies the following conditional expression (7):

$$1. 50 < f 1 / ( - fR 3 ) < 6.00 \qquad ( 7 )$$

where fR3 is the focal length of the third succeeding lens group GR3.

The conditional expression (7) defines an appropriate relationship between the focal length of the object lens group GA and the focal length of the third succeeding lens group GR3. Satisfying the conditional expression (7) allows for correcting the coma aberration well.

If the corresponding value of the conditional expression (7) exceeds the upper limit, the refractive power of the object lens group GA weakens more than that of the third succeeding lens group GR3 and it becomes difficult to correct the coma aberration. Setting the upper limit of the conditional expression (7) to 5.50, 5.00, 4.50, or even 4.00 allows for ensuring the advantage of each embodiment more firmly.

If the corresponding value of the conditional expression (7) falls below the lower limit, the refractive power of the third succeeding lens group GR3 weakens and it becomes difficult to miniaturize the zoom optical system ZL while correcting the coma aberration. Setting the lower limit of the conditional expression (7) to 1.60, 1.70, 1.80, 1.90, or even 2.00 allows for ensuring the advantage of each embodiment more firmly.

In the zoom optical system ZL of the first and second embodiments, the third succeeding lens group GR3 preferably comprises a lens satisfying the following conditional expressions (8) and (9):

$$50. < vd 3 < 80. \qquad ( 8 )$$

$$1.45 < nd 3 < 1.58 \qquad ( 9 )$$

where vd3 is the Abbe number of the lens in the third succeeding lens group GR3, and nd3 is the refractive index of the lens in the third succeeding lens group GR3 at the d-line.

The conditional expression (8) defines an appropriate range for the Abbe number of the lens in the third succeeding lens group GR3. The conditional expression (9) defines an appropriate range for the refractive index of the lens in the third succeeding lens group GR3 at the d-line. Satisfying the conditional expressions (8) and (9) allows for correcting the chromatic aberration of magnification well.

If the corresponding value of the conditional expression (8) exceeds the upper limit, the material of the lens in the third succeeding lens group GR3 will be special glass, which increases manufacturing costs. Setting the upper limit of the conditional expression (8) to 79.0, 78.0, 77.0, or even 75.0 allows for ensuring the advantage of each embodiment more firmly.

If the corresponding value of the conditional expression (8) falls below the lower limit, it becomes difficult to correct the chromatic aberration of magnification. Setting the lower limit of the conditional expression (8) to 51.0, 52.0, 53.0,54.0, or even 55.0 allows for ensuring the advantage of each embodiment more firmly.

If the corresponding value of the conditional expression (9) exceeds the upper limit, the material of the lens in the third succeeding lens group GR3 will be a high refractive index material, which increases the weight. Setting the upper limit of the conditional expression (9) to 1.57, 1.56, or even 1.55 allows for ensuring the advantage of each embodiment more firmly.

If the corresponding value of the conditional expression (9) falls below the lower limit, the material of the lens in the third succeeding lens group GR3 will be a low refractive index material, which requires a high surface curvature of the lens, and therefore it becomes difficult to correct the distortion. Setting the lower limit of the conditional expression (9) to 1.46, 1.47, or even 1.48 allows for ensuring the advantage of each embodiment more firmly.

The zoom optical system ZL of the first and second embodiments preferably satisfies the following conditional expression (10):

$$1. 80 < TLw / ( - fR 3 ) < 2.70 \qquad ( 10 )$$

where TLw is the entire length of the zoom optical system ZL in the wide-angle end state, and fR3 is the focal length of the third succeeding lens group GR3.

The conditional expression (10) defines an appropriate relationship between the entire length of the zoom optical system ZL in the wide-angle end state and the focal length of the third succeeding lens group GR3. Satisfying the conditional expression (10) allows for shortening the entire length of the zoom optical system ZL while maintaining good optical performance.

If the corresponding value of the conditional expression (10) exceeds the upper limit, the refractive power of the third succeeding lens group GR3 strengthens and it becomes difficult to suppress the fluctuation in distortion upon zooming. Setting the upper limit of the conditional expression (10) to 2.65, 2.60, 2.55, or even 2.50 allows for ensuring the advantage of each embodiment more firmly.

If the corresponding value of the conditional expression (10) falls below the lower limit, the entire length of the zoom optical system ZL in the wide-angle end state increases and it becomes difficult to shorten the entire length of the zoom optical system ZL. Setting the lower limit of the conditional expression (10) to 1.85, 1.90, 1.95, or even 2.00 allows for ensuring the advantage of each embodiment more firmly.

The zoom optical system ZL of the first and second embodiments preferably satisfies the following conditional expression (11):

$$0. 30 < ( - fR 1 ) / fR 2 < 1.30 \qquad ( 11 )$$

where fR1 is the focal length of the first succeeding lens group GR1, and fR2 is the focal length of the second succeeding lens group GR2.

The conditional expression (11) defines an appropriate relationship between the focal length of the first succeeding lens group GR1 and the focal length of the second succeeding lens group GR2. Satisfying the conditional expression (11) allows for correcting the spherical aberration well.

If the corresponding value of the conditional expression (11) exceeds the upper limit, the refractive power of the first succeeding lens group GR1 weakens and it becomes difficult to miniaturize the zoom optical system ZL while correcting the spherical aberration. Setting the upper limit of the conditional expression (11) to 1.20, 1.10, 1.00, or even 0.90 allows for ensuring the advantage of each embodiment more firmly.

If the corresponding value of the conditional expression (11) falls below the lower limit, the refractive power of the first succeeding lens group GR1 strengthens and it becomes difficult to correct the spherical aberration. Setting the lower limit of the conditional expression (11) to 0.40, 0.50, or even 0.60 allows for ensuring the advantage of each embodiment more firmly.

The zoom optical system ZL of the first and second embodiments preferably satisfies the following conditional expression (12):

$$0. 70 < ( - fR 1 ) / fMw < 2.00 \qquad ( 12 )$$

where fR1 is the focal length of the first succeeding lens group GR1, and fMw is the combined focal length of the intermediate group GM in the wide-angle end state.

The conditional expression (12) defines an appropriate relationship between the focal length of the first succeeding lens group GR1 and the combined focal length of the intermediate group GM in the wide-angle end state. Satisfying the conditional expression (12) allows for correcting the spherical aberration well.

If the corresponding value of the conditional expression (12) exceeds the upper limit, the refractive power of the first succeeding lens group GR1 weakens and it becomes difficult to miniaturize the zoom optical system ZL while correcting the spherical aberration. Setting the upper limit of the conditional expression (12) to 1.90, 1.80, 1.70, or even 1.65 allows for ensuring the advantage of each embodiment more firmly.

If the corresponding value of the conditional expression (12) falls below the lower limit, the refractive power of the first succeeding lens group GR1 strengthens and it becomes difficult to suppress the fluctuation in spherical aberration upon zooming. Setting the lower limit of the conditional expression (12) to 0.80, 0.90, 1.00, or even 1.10 allows for ensuring the advantage of each embodiment more firmly.

The zoom optical system ZL of the first and second embodiments preferably satisfies the following conditional expression (13):

$$1. 00 < fR 2 / fMw < 3. \qquad ( 13 )$$

where fR2 is the focal length of the second succeeding lens group GR2, and fMw is the combined focal length of the intermediate group GM in the wide-angle end state.

The conditional expression (13) defines an appropriate relationship between the focal length of the second succeeding lens group GR2 and the combined focal length of the intermediate group GM in the wide-angle end state. Satisfying the conditional expression (13) allows for correcting the curvature of field well.

If the corresponding value of the conditional expression (13) exceeds the upper limit, the refractive power of the second succeeding lens group GR2 weakens and it becomes difficult to miniaturize the zoom optical system ZL while correcting the curvature of field. Setting the upper limit of the conditional expression (13) to 2.90, 2.80, 2.70, 2.60, or even 2.50 allows for ensuring the advantage of each embodiment more firmly.

If the corresponding value of the conditional expression (13) falls below the lower limit, the refractive power of the second succeeding lens group GR2 strengthens and it becomes difficult to correct the curvature of field. Setting the lower limit of the conditional expression (13) to 1.10, 1.20, 1.30, 1.35, or even 1.40 allows for ensuring the advantage of each embodiment more firmly.

The zoom optical system ZL of the first and second embodiments preferably satisfies the following conditional expression (14):

$$1. 00 < ( - fR 3 ) / fMw < 3.50 \qquad ( 14 )$$

where fR3 is the focal length of the third succeeding lens group GR3, and fMw is the combined focal length of the intermediate group GM in the wide-angle end state.

The conditional expression (14) defines an appropriate relationship between the focal length of the third succeeding lens group GR3 and the combined focal length of the intermediate group GM in the wide-angle end state. Satisfying the conditional expression (14) allows for miniaturization while correcting the distortion well.

If the corresponding value of the conditional expression (14) exceeds the upper limit, the refractive power of the third succeeding lens group GR3 weakens and it becomes difficult to miniaturize the zoom optical system ZL while correcting the distortion. Setting the upper limit of the conditional expression (14) to 3.00, 2.50, 2.25, or even 2.00 allows for ensuring the advantage of each embodiment more firmly.

If the corresponding value of the conditional expression (14) falls below the lower limit, the refractive power of the third succeeding lens group GR3 strengthens and it becomes difficult to correct the distortion. Setting the lower limit of the conditional expression (14) to 1.10, 1.15, 1.20, or even 1.25 allows for ensuring the advantage of each embodiment more firmly.

The zoom optical system ZL of the first and second embodiments preferably satisfies the following conditional expression (15):

$$0. 10 < Bft / ft < 0.80 \qquad ( 15 )$$

where Bft is the back focus of the zoom optical system ZL in the telephoto end state, and ft is the focal length of the zoom optical system ZL in the telephoto end state.

The conditional expression (15) defines an appropriate relationship between the back focus of the zoom optical system ZL in the telephoto end state and the focal length of the zoom optical system ZL in the telephoto end state. Satisfying the conditional expression (15) allows for obtaining a zoom optical system that is small yet with bright and good optical performance. Setting the upper limit of the conditional expression (15) to 0.75, 0.70, 0.65, 0.60, or even 0.50 allows for ensuring the advantage of the embodiments more firmly. Setting the lower limit of the conditional expression (15) to 0.15, 0.20, 0.25, or even 0.30 allows for ensuring the advantage of the embodiments more firmly.

In the zoom optical system ZL of the first and second embodiments, the third succeeding lens group GR3 is preferably fixed relative to the image plane I upon zooming. This allows for simplifying the structure of components holding each lens group or the like, so that the weight of the zoom optical system ZL can be reduced.

In the zoom optical system ZL of the first and second embodiments, the first succeeding lens group GR1 preferably moves on the optical axis upon focusing. This allows for suppressing the fluctuation in curvature of field upon focusing well.

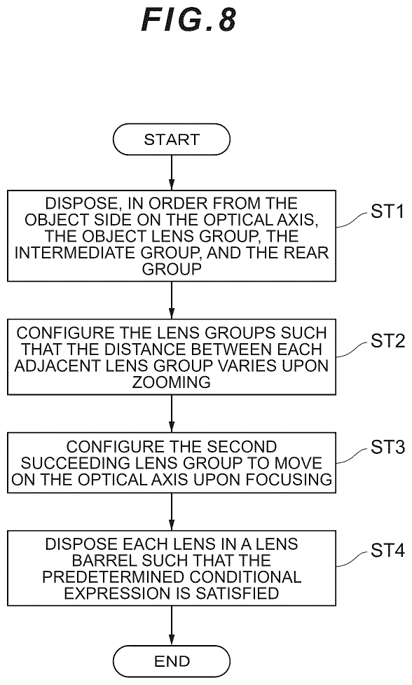

Subsequently, a method for manufacturing the zoom optical system ZL of the first embodiment will be outlined with reference to FIG. 8. First, the object lens group having positive refractive power, GA, the intermediate group having positive refractive power, GM, and the rear group GR are disposed in order from the object side on the optical axis (Step ST1). In this step, at least one lens group is disposed in the intermediate group GM. The first succeeding lens group having negative refractive power, GR1, the second succeeding lens group having positive refractive power, GR2, and the third succeeding lens group having negative refractive power, GR3, are disposed in the rear group GR in order from the object side on the optical axis. Next, the lens groups are configured such that the distance between each adjacent lens group varies upon zooming (Step ST2). Next, the second succeeding lens group GR2 is configured to move on the optical axis upon focusing (Step ST3). Then, each lens is disposed in a lens barrel such that at least the above-described conditional expression (1) is satisfied (Step ST4). Such a manufacturing method allows for manufacturing a zoom optical system that is small yet with bright and good optical performance.

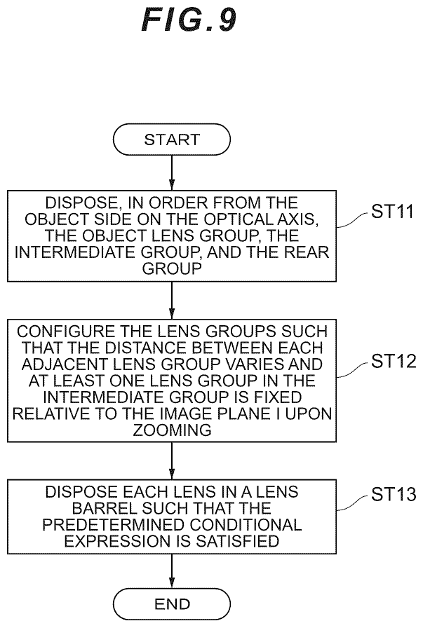

Subsequently, a method for manufacturing the zoom optical system ZL of the second embodiment will be outlined with reference to FIG. 9. First, the object lens group having positive refractive power, GA, the intermediate group having positive refractive power, GM, and the rear group GR are disposed in order from the object side on the optical axis (Step ST11). In this step, at least one lens group is disposed in the intermediate group GM. The first succeeding lens group having negative refractive power, GR1, the second succeeding lens group having positive refractive power, GR2, and the third succeeding lens group having negative refractive power, GR3, are disposed in the rear group GR in order from the object side on the optical axis. Next, the lens groups are configured such that the distance between each adjacent lens group varies and at least one lens group in the intermediate group GM is fixed relative to the image plane I upon zooming (Step ST12). Then, each lens is disposed in a lens barrel such that at least the above-described conditional expression (2) is satisfied (Step ST13). Such a manufacturing method allows for manufacturing a zoom optical system that is small yet with bright and good optical performance.

### EXAMPLES

Now, the zoom optical system ZL of an example of each embodiment will be described with reference to the drawings. FIGS. 1, 3, and 5 are sectional views showing the configurations and refractive power distributions of the zoom optical system ZL, ZL (1) to ZL (3), of first to third examples. In the sectional views of the zoom optical systems ZL (1) to ZL (3) of the first to third examples, the direction of movement of each lens group upon zooming from the wide-angle end state (W) to the telephoto end state (T) is indicated by an arrow. The direction of movement of a focusing lens group upon focusing on a short-distance object from infinity is also indicated by an arrow with a text “Focusing”.

In these FIGS. 1, 3, and 5, each lens group and each lens are denoted by a combination of a designation G and a numeral, and a combination of a designation L and a numeral, respectively. In this case, combinations of designations and numerals are independently used to denote lens groups and the like for each example in order to prevent the types and numbers of those designations and numerals from increasing to cause complication. For this reason, the use of the same designation and numeral combination in different examples does not mean that they have the same configuration.

Tables 1 to 3 are presented below, where Tables 1, 2, and 3 show each data in the first, second, and third examples, respectively. In each example, the d-line (wavelength λ=587.6 nm) and the g-line (wavelength λ=435.8 nm) are chosen to calculate aberration characteristics.

In [General Data] tables, f denotes the focal length of the entire lens system, FNO denotes the f-number, 2 ω denotes the angle of view (the unit is °, degree, and ω is the half angle of view), and Y denotes the image height. TL denotes the distance on the optical axis from the lens surface closest to the object side to the lens surface closest to the image side of the zoom optical system upon focusing on infinity added with Bf (the back focus), and Bf denotes the distance (air equivalent distance) on the optical axis from the lens surface closest to the image side to the image plane of the zoom optical system upon focusing on infinity. Note that these values are shown for each zooming state, namely the wide-angle end state (W), an intermediate focal length state (M), and the telephoto end state (T). In the [General Data] tables, fMw denotes the combined focal length of the intermediate group in the wide-angle end state.

In [Lens Data] tables, Surface number denotes the order of the optical surface counted from the object side along the traveling direction of light rays, R denotes the radius of curvature of each optical surface (this is positive when the surface's center of curvature is positioned on the image side), D denotes the surface distance that is the distance on the optical axis from each optical surface to the next optical surface (or the image plane), nd denotes the refractive index of the material of the optical element at the d-line, and vd denotes the Abbe number of the material of the optical element relative to the d-line. A radius of curvature “∞” denotes a plane or an aperture, and “(Aperture Stop)” denotes an aperture stop S. The description of the refractive index of air, nd=1.00000, is omitted. If the optical surface is aspherical, a mark * is attached to the Surface number and the field of the radius of curvature R shows the paraxial radius of curvature.

[Aspherical surface data] tables present the shapes of aspherical surfaces shown in [Lens Data] using the following equation (A). X(y) denotes the distance along the optical axis from the plane tangent to the vertex of the aspherical surface to the point on the aspherical surface at a height y (the sag amount), R denotes the radius of curvature of the reference spherical surface (the paraxial radius of curvature), K denotes the conical constant, and Ai denotes the aspherical coefficient of the i-th order. “E-n” denotes “x10⁻ⁿ.” For example, 1.234E-05=1.234×10⁻⁵. Note that the aspherical coefficient of the second order, A2, is zero, and its description is omitted.

$$X ( y ) = ( {y}^{2} / R ) / [ 1 + {( 1 - κ \times {y}^{2} / {R}^{2} )}^{1 / 2} ] + A 4 \times {y}^{4} + A 6 \times {y}^{6} + A 8 \times {y}^{8} + A 10 \times {y}^{10} + A 12 \times {y}^{12} \qquad ( A )$$

[Variable distance data] tables show the surface distance for each Surface number i whose surface distance is shown as “(Di)” in the [Lens Data] tables. The [Variable distance data] tables also show surface distances upon focusing on infinity and surface distances upon focusing on a short-distance object. DO shows the distance from the object to the lens surface closest to the object in the zoom optical system.

[Lens group data] tables show the first surface (the surface closest to the object side) and focal length of each lens group.

For all data values listed below including the focal length f, the radius of curvature R, the surface distance D, and other lengths, “mm” is generally used if not otherwise specified. However, this is not the only way since optical systems provide equivalent optical performance even if they are proportionally enlarged or reduced.

The foregoing description of the tables is common to all the examples, and repeated description will be omitted below.

### First Example

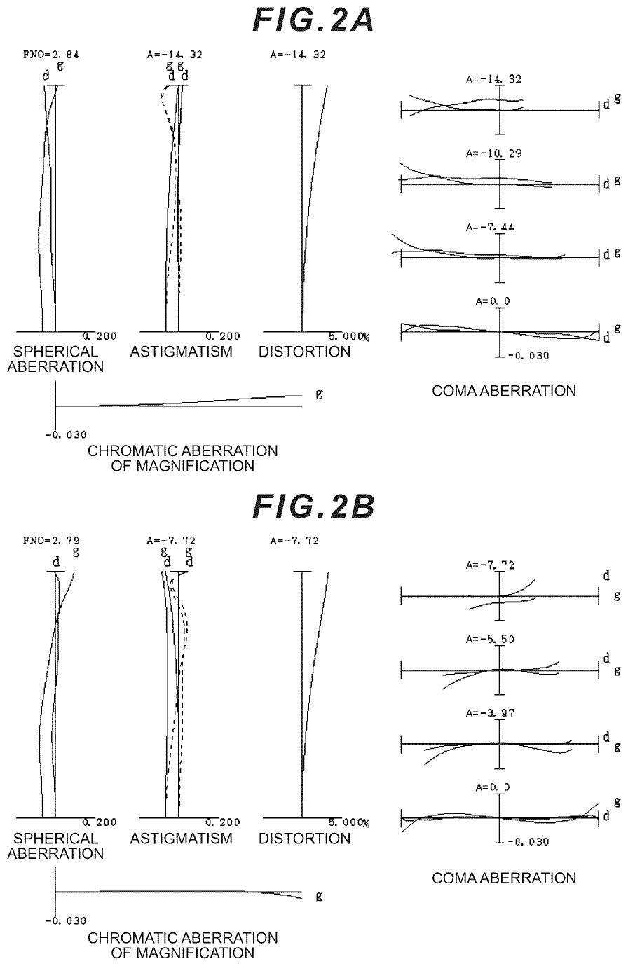

The first example will be described with reference to FIGS. 1 to 2 and Table 1. FIG. 1 shows a lens configuration of the zoom optical system of the first example. The zoom optical system ZL (1) of the first example comprises, in order from the object side on the optical axis, a first lens group having positive refractive power, G1, a second lens group having negative refractive power, G2, a third lens group having positive refractive power, G3, a fourth lens group having negative refractive power, G4, a fifth lens group having positive refractive power, G5, and a sixth lens group having negative refractive power, G6. Upon zooming from the wide-angle end state (W) to the telephoto end state (T), the first lens group G1 and the fourth lens group G4 move on the optical axis toward the object side, the second lens group G2 and the fifth lens group G5 move on the optical axis toward the image side, and the distance between each adjacent lens group varies. The third lens group G3 and the sixth lens group G6 are fixed relative to an image plane I upon zooming. An aperture stop S is disposed between the second lens group G2 and the third lens group G3, and moves with the second lens group G2 on the optical axis upon zooming. A symbol (+) or (−) attached to each lens group designation represents the refractive power of each lens group, and this applies to all the following examples.

The first lens group G1 comprises, in order from the object side on the optical axis, a cemented positive lens constructed by a negative meniscus lens having a convex surface facing the object side, L11, cemented with a biconvex positive lens L12, and a biconvex positive lens L13.

The second lens group G2 comprises, in order from the object side on the optical axis, a cemented negative lens constructed by a biconcave negative lens L21 cemented with a positive meniscus lens having a convex surface facing the object side, L22, and a biconcave negative lens L23.

The third lens group G3 comprises, in order from the object side on the optical axis, a positive meniscus lens having a convex surface facing the object side, L31, a biconvex positive lens L32, a cemented negative lens constructed by a biconcave negative lens L33 cemented with a positive meniscus lens having a convex surface facing the object side, L34, a positive lens being convex on the object side, L35, and a biconvex positive lens L36. The lens surfaces on both sides of the positive lens L35 are aspherical.

The fourth lens group G4 comprises a cemented negative lens constructed by a positive meniscus lens having a convex surface facing the object side, L41, cemented with a negative meniscus lens having a convex surface facing the object side, L42.

The fifth lens group G5 comprises a positive meniscus lens having a concave surface facing the object side, L51. The lens surfaces on both sides of the positive meniscus lens L51 are aspherical.

The sixth lens group G6 comprises a negative meniscus lens having a concave surface facing the object side, L61. The lens surface on the object side of the negative meniscus lens L61 is aspherical. The image plane I is disposed on the image side of the sixth lens group G6.

In the present example, the first lens group G1 corresponds to the object lens group GA. The second lens group G2 and the third lens group G3 comprise the intermediate group GM having positive refractive power as a whole. The fourth lens group G4 corresponds to the first succeeding lens group GR1 being part of the rear group GR. The fifth lens group G5 corresponds to the second succeeding lens group GR2 being part of the rear group GR. The sixth lens group G6 corresponds to the third succeeding lens group GR3 being part of the rear group GR. Upon focusing on a short-distance object from an object at infinity, the first succeeding lens group GR1 (the fourth lens group G4) moves on the optical axis toward the image side, and the second succeeding lens group GR2 (the fifth lens group G5) moves on the optical axis toward the object side.

Data values of the zoom optical system of the first example will be listed on Table 1 below.

TABLE 1
[General Data]
Zooming ratio = 2.354
fMw = 45.030

| | W | M | T |
|---|---|---|---|
| f | 82.400 | 115.000 | 194.000 |
| FNO | 2.910 | 2.910 | 2.910 |
| 2ω | 28.655 | 20.555 | 12.452 |
| Y | 21.600 | 21.600 | 21.600 |
| TL | 142.000 | 183.500 | 223.700 |
| Bf | 16.055 | 16.055 | 16.055 |

[Lens Data]

| Surface | | | | |
|---|---|---|---|---|
| number | R | D | nd | νd |
| 1 | 171.877 | 2.200 | 1.90366 | 31.27 |
| 2 | 114.587 | 7.087 | 1.43700 | 95.10 |
| 3 | −1237.212 | 0.100 | | |
| 4 | 123.415 | 6.288 | 1.43700 | 95.10 |
| 5 | −6347.604 | (D5) | | |
| 6 | −177.063 | 1.500 | 1.48749 | 70.32 |
| 7 | 32.128 | 3.865 | 1.66382 | 27.35 |
| 8 | 55.335 | 3.525 | | |
| 9 | −129.581 | 1.500 | 1.56384 | 60.71 |
| 10 | 268.506 | 1.997 | | |
| 11 | ∞ | (D11) | | (Aperture |
| | | | | Stop) |
| 12 | 46.856 | 3.567 | 1.94595 | 17.98 |
| 13 | 107.185 | 2.885 | | |
| 14 | 49.829 | 4.450 | 1.51860 | 69.89 |
| 15 | −1266.722 | 2.161 | | |
| 16 | −255.399 | 1.491 | 1.92286 | 20.88 |
| 17 | 29.834 | 4.780 | 1.43700 | 95.10 |
| 18 | 151.838 | 0.329 | | |
| 19* | 48.160 | 3.811 | 1.59245 | 66.92 |
| 20* | ∞ | 8.140 | | |
| 21 | 91.502 | 4.163 | 1.79952 | 42.09 |
| 22 | −76.369 | (D22) | | |
| 23 | 68.549 | 2.667 | 1.94595 | 17.98 |
| 24 | 229.390 | 1.234 | 1.76684 | 46.78 |
| 25 | 23.740 | (D25) | | |
| 26* | −90.743 | 5.919 | 1.59245 | 66.92 |
| 27* | −28.235 | (D27) | | |
| 28* | −27.328 | 1.800 | 1.48749 | 70.32 |
| 29 | −1984.395 | Bf | | |

[Aspherical surface data]
19th surface
κ = 0.000, A4 = 1.504E−09, A6 = −6.079E−09, A8 = 4.173E−11,
A10 = −1.301E−13, A12 = 1.109E−16
20th surface
κ = 0.000, A4 = 5.705E−06, A6 = −4.363E−09,
A8 = 2.313E−11, A10 = −5.797E−14, A12 = 0.000E+00
26th surface
κ = 0.000, A4 = 3.822E−07, A6 = 2.351E−08, A8 = −1.490E−10,
A10 = 5.248E−13, A12 = −1.193E−15
27th surface
κ = 0.000, A4 = 8.257E−06, A6 = 2.275E−08, A8 = −1.369E−10,
A10 = 4.522E−13, A12 = −9.834E−16
28th Surface
κ = 0.000, A4 = 1.670E−05, A6 = 3.104E−09, A8 = 4.253E−12,
A10 = −5.342E−14, A12 = 1.371E−16

[Variable distance data]

| | | |
|---|---|---|
| W | M | T |

Upon focusing on infinity

| | | | |
|---|---|---|---|
| Focal length | 82.400 | 115.000 | 194.000 |
| Distance | ∞ | ∞ | ∞ |
| D5 | 2.268 | 45.455 | 74.464 |
| D11 | 8.943 | 7.215 | 5.299 |
| D22 | 12.359 | 9.050 | 5.044 |
| D25 | 18.808 | 24.308 | 30.596 |
| D27 | 7.608 | 5.416 | 3.135 |

Upon focusing on a short-distance object

| | | | |
|---|---|---|---|
| Zoom | 0.0906 | 0.1207 | 0.1786 |
| magnification | | | |
| Distance | 858.088 | 816.520 | 776.229 |
| D5 | 2.268 | 45.455 | 74.464 |
| D11 | 8.943 | 7.215 | 5.299 |
| D22 | 15.090 | 14.130 | 12.840 |
| D25 | 14.310 | 16.930 | 20.630 |
| D27 | 9.370 | 7.710 | 5.300 |

[Lens group data]

| | First | Focal |
|---|---|---|
| Group | surface | length |
| G1 | 1 | 195.199 |
| G2 | 6 | −63.022 |
| G3 | 12 | 39.950 |
| G4 | 23 | −54.456 |
| G5 | 26 | 66.832 |
| G6 | 28 | −56.858 |

FIG. 2 (A) presents graphs showing various aberrations of the zoom optical system of the first example upon focusing on infinity in the wide-angle end state. FIG. 2 (B) presents graphs showing various aberrations of the zoom optical system of the first example upon focusing on infinity in the telephoto end state. In each of the graphs showing various aberrations, FNO denotes the f-number, and A denotes the half angle of view. Note that a spherical aberration graph shows the value of the f-number corresponding to the maximum aperture, an astigmatism graph and a distortion graph each show the maximum half angle of view, and a coma aberration graph shows the value of each half angle of view. The lowercase d denotes the d-line (wavelength λ=587.6 nm), and g denotes the g-line (wavelength λ=435.8 nm). In the astigmatism graph, solid lines show sagittal image surfaces and dashed lines show meridional image surfaces. Note that the same symbols as the present example will be used also in graphs showing aberrations of each example shown below, and repeated description will be omitted.

Each of the graphs showing various aberrations demonstrates that the zoom optical system of the first example has well-corrected various aberrations throughout the wide-angle end state and the telephoto end state and excellent image formation performance.

### Second Example

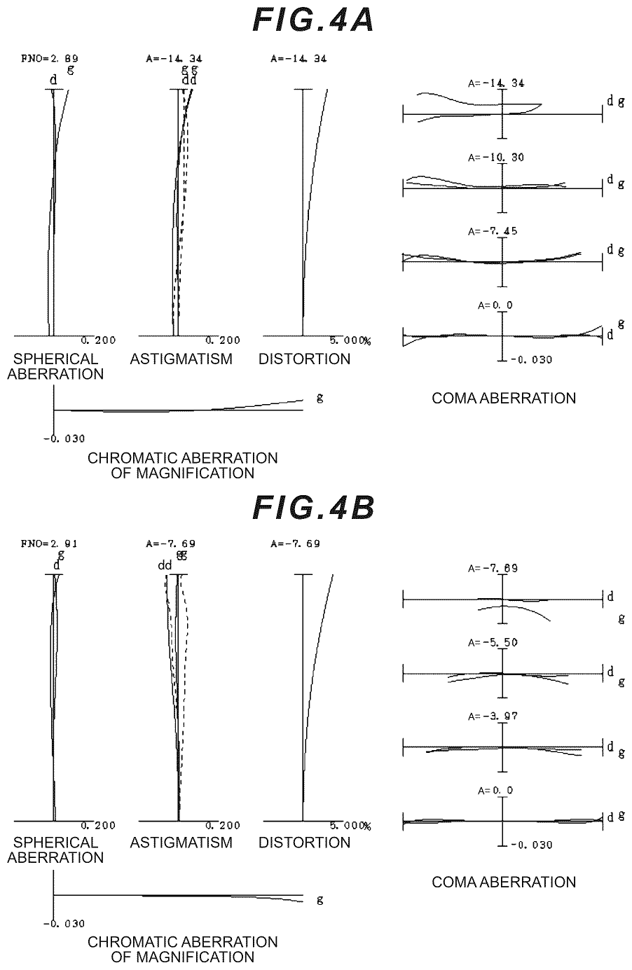

The second example will be described with reference to FIGS. 3 to 4 and Table 2. FIG. 3 shows a lens configuration of the zoom optical system of the second example. The zoom optical system ZL (2) of the second example comprises, in order from the object side on the optical axis, a first lens group having positive refractive power, G1, a second lens group having positive refractive power, G2, a third lens group having negative refractive power, G3, a fourth lens group having positive refractive power, G4, and a fifth lens group having negative refractive power, G5. Upon zooming from the wide-angle end state (W) to the telephoto end state (T), the first lens group G1 and the third lens group G3 move on the optical axis toward the object side, the fourth lens group G4 moves on the optical axis toward the image side, and the distance between each adjacent lens group varies. The second lens group G2 and the fifth lens group G5 are fixed relative to an image plane I upon zooming. An aperture stop S is disposed within the second lens group G2, and is fixed relative to the image plane I upon zooming.

The first lens group G1 comprises, in order from the object side on the optical axis, a cemented positive lens constructed by a negative meniscus lens having a convex surface facing the object side, L11, cemented with a positive meniscus lens having a convex surface facing the object side, L12, and a biconvex positive lens L13.

The second lens group G2 comprises, in order from the object side on the optical axis, a cemented negative lens constructed by a biconcave negative lens L21 cemented with a positive meniscus lens having a convex surface facing the object side, L22, a biconcave negative lens L23, a biconvex positive lens L24, a biconvex positive lens L25, a cemented negative lens constructed by a biconcave negative lens L26 cemented with a biconvex positive lens L27, a biconvex positive lens L28, and a biconvex positive lens L29. The lens surfaces on both sides of the positive lens L28 are aspherical. An aperture stop S is disposed between the negative lens L23 and the positive lens L24 in the second lens group G2.

The third lens group G3 comprises a cemented negative lens constructed by a biconvex positive lens L31 cemented with a biconcave negative lens L32.

The fourth lens group G4 comprises a positive meniscus lens having a concave surface facing the object side, L41. The lens surfaces on both sides of the positive meniscus lens L41 are aspherical.

The fifth lens group G5 comprises a negative meniscus lens having a concave surface facing the object side, L51. The lens surfaces on both sides of the negative meniscus lens L51 are aspherical. The image plane I is disposed on the image side of the fifth lens group G5.

In the present example, the first lens group G1 corresponds to the object lens group GA. The second lens group G2 constitutes the intermediate group GM having positive refractive power as a whole. The third lens group G3 corresponds to the first succeeding lens group GR1 being part of the rear group GR. The fourth lens group G4 corresponds to the second succeeding lens group GR2 being part of the rear group GR. The fifth lens group G5 corresponds to the third succeeding lens group GR3 being part of the rear group GR. Upon focusing on a short-distance object from an object at infinity, the first succeeding lens group GR1 (the third lens group G3) moves on the optical axis toward the image side, and the second succeeding lens group GR2 (the fourth lens group G4) moves on the optical axis toward the object side.

Data values of the zoom optical system of the second example will be listed on Table 2 below.

TABLE 2
[General Data]
Zooming ratio = 2.354
fMw = 44.470

| | W | M | T |
|---|---|---|---|
| f | 82.400 | 115.000 | 194.000 |
| FNO | 2.910 | 2.910 | 2.910 |
| 2ω | 28.666 | 20.520 | 12.390 |
| Y | 21.600 | 21.600 | 21.600 |
| TL | 141.300 | 181.600 | 223.000 |
| Bf | 17.580 | 17.580 | 17.580 |

[Lens Data]

| Surface | | | | |
|---|---|---|---|---|
| number | R | D | nd | νd |
| 1 | 140.242 | 2.500 | 1.95375 | 32.33 |
| 2 | 93.845 | 7.711 | 1.43700 | 95.10 |
| 3 | 3243.579 | 0.100 | | |
| 4 | 115.926 | 7.006 | 1.49700 | 81.64 |
| 5 | −1142.670 | (D5) | | |
| 6 | −107.638 | 1.500 | 1.49700 | 81.64 |
| 7 | 44.592 | 3.895 | 1.66382 | 27.35 |
| 8 | 154.097 | 3.169 | | |
| 9 | −52.031 | 1.500 | 1.51823 | 58.82 |
| 10 | 343.677 | 6.157 | | |
| 11 | ∞ | 2.955 | | (Aperture |
| | | | | Stop) |
| 12 | 215.864 | 4.047 | 1.94595 | 17.98 |
| 13 | −76.395 | 1.807 | | |
| 14 | 301.612 | 3.389 | 1.59319 | 67.90 |
| 15 | −91.000 | 0.595 | | |
| 16 | −64.738 | 1.474 | 1.92286 | 20.88 |
| 17 | 37.030 | 5.294 | 1.43700 | 95.10 |
| 18 | −201.403 | 1.095 | | |
| 19* | 44.800 | 4.784 | 1.59255 | 67.86 |
| 20* | −258.339 | 0.100 | | |
| 21 | 121.430 | 3.915 | 1.79950 | 42.34 |
| 22 | −95.231 | (D22) | | |
| 23 | 121.448 | 2.670 | 1.94595 | 17.98 |
| 24 | −383.141 | 1.224 | 1.72000 | 43.61 |
| 25 | 25.672 | (D25) | | |
| 26* | −73.480 | 5.620 | 1.67790 | 54.89 |
| 27* | −28.683 | (D27) | | |
| 28* | −30.014 | 1.900 | 1.48749 | 70.32 |
| 29* | −317.720 | Bf | | |

[Aspherical surface data]
19th surface
κ = 0.000, A4 = −2.580E−06, A6 = −2.781E−09, A8 = 6.087E−12,
A10 = −1.542E−14, A12 = 1.672E−17
20th surface
κ = 0.000, A4 = 9.392E−08, A6 = −2.660E−09, A8 = 2.889E−12,
A10 = −4.235E−15, A12 = 0.000E+00
26th surface
κ = 0.000, A4 = −1.401E−06, A6 = 8.643E−09, A8 = −1.465E−11,
A10 = −2.254E−14, A12 = −1.063E−16
27th surface
κ = 0.000, A4 = 5.349E−06, A6 = 7.127E−09, A8 = −1.507E−11,
A10 = 7.454E−15, A12 = −1.405E−16
28th surface
κ = 0.000, A4 = 2.023E−05, A6 = −3.714E−08, A8 = 1.151E−10,
A10 = −1.819E−13, A12 = 1.124E−16
29th surface
κ = 0.000, A4 = 7.556E−06, A6 = −3.415E−08, A8 = 1.029E−10,
A10 = −1.477E−13, A12 = 6.108E−17

[Variable distance data]

| | | |
|---|---|---|
| W | M | T |

Upon focusing on infinity

| | | | |
|---|---|---|---|
| Focal length | 82.400 | 115.000 | 194.000 |
| Distance | ∞ | ∞ | ∞ |
| D5 | 2.685 | 42.953 | 84.443 |
| D22 | 12.981 | 9.243 | 1.500 |
| D25 | 23.498 | 29.829 | 43.044 |
| D27 | 9.566 | 6.973 | 1.500 |

Upon focusing on a short-distance object

| | | | |
|---|---|---|---|
| Zoom | 0.0916 | 0.1229 | 0.1796 |
| magnification | | | |
| Distance | 858.824 | 818.461 | 776.971 |
| D5 | 2.685 | 42.953 | 84.443 |
| D22 | 15.210 | 13.450 | 10.380 |
| D25 | 19.410 | 23.250 | 29.550 |
| D27 | 11.430 | 9.340 | 6.120 |

[Lens group data]

| | First | Focal |
|---|---|---|
| Group | surface | length |
| G1 | 1 | 171.084 |
| G2 | 6 | 44.469 |
| G3 | 23 | −52.063 |
| G4 | 26 | 66.055 |
| G5 | 28 | −68.139 |

FIG. 4 (A) presents graphs showing various aberrations of the zoom optical system of the second example upon focusing on infinity in the wide-angle end state. FIG. 4 (B) presents graphs showing various aberrations of the zoom optical system of the second example upon focusing on infinity in the telephoto end state. Each of the graphs showing various aberrations demonstrates that the zoom optical system of the second example has well-corrected various aberrations throughout the wide-angle end state and the telephoto end state and excellent image formation performance.

### Third Example

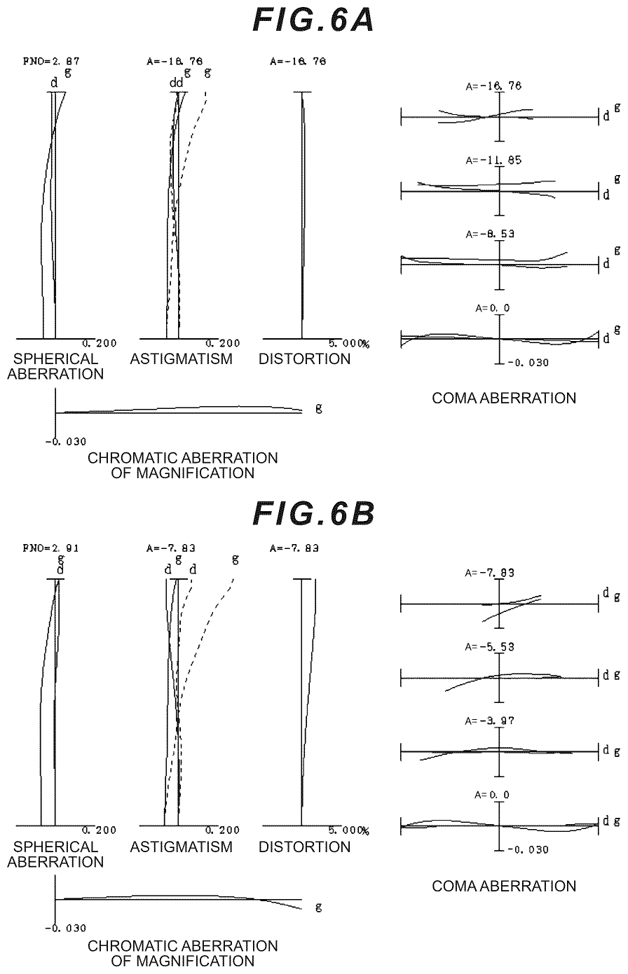

The third example will be described with reference to FIGS. 5 to 6 and Table 3. FIG. 5 shows a lens configuration of the zoom optical system of the third example. The zoom optical system ZL (3) of the third example comprises, in order from the object side on the optical axis, a first lens group having positive refractive power, G1, a second lens group having negative refractive power, G2, a third lens group having positive refractive power, G3, a fourth lens group having positive refractive power, G4, a fifth lens group having negative refractive power, G5, a sixth lens group having positive refractive power, G6, and a seventh lens group having negative refractive power, G7. Upon zooming from the wide-angle end state (W) to the telephoto end state (T), the first lens group G1, the third lens group G3, and the fifth lens group G5 move on the optical axis toward the object side, the second lens group G2 and the sixth lens group G6 move on the optical axis toward the image side, and the distance between each adjacent lens group varies. The fourth lens group G4 and the seventh lens group G7 are fixed relative to an image plane I upon zooming. An aperture stop S is disposed between the second lens group G2 and the third lens group G3, and moves with the third lens group G3 on the optical axis upon zooming.

The first lens group G1 comprises, in order from the object side on the optical axis, a cemented positive lens constructed by a negative meniscus lens having a convex surface facing the object side, L11, cemented with a biconvex positive lens L12, and a positive meniscus lens having a convex surface facing the object side, L13.

The second lens group G2 comprises, in order from the object side on the optical axis, a cemented negative lens constructed by a biconcave negative lens L21 cemented with a positive meniscus lens having a convex surface facing the object side, L22, and a biconcave negative lens L23.

The third lens group G3 comprises a positive meniscus lens having a convex surface facing the object side, L31.

The fourth lens group G4 comprises, in order from the object side on the optical axis, a positive meniscus lens having a convex surface facing the object side, L41, a cemented negative lens constructed by a negative meniscus lens having a convex surface facing the object side, L42, cemented with a positive meniscus lens having a convex surface facing the object side, L43, a positive meniscus lens having a convex surface facing the object side, L44, and a biconvex positive lens L45. The lens surfaces on both sides of the positive meniscus lens L44 are aspherical.

The fifth lens group G5 comprises a cemented negative lens constructed by a positive meniscus lens having a convex surface facing the object side, L51, cemented with a negative meniscus lens having a convex surface facing the object side, L52.

The sixth lens group G6 comprises a positive meniscus lens having a concave surface facing the object side, L61. The lens surfaces on both sides of the positive meniscus lens L61 are aspherical.

The seventh lens group G7 comprises a plano-concave negative lens having a plane surface facing the image side, L71. The lens surface on the object side of the negative lens L71 is aspherical. The image plane I is disposed on the image side of the seventh lens group G7.

In the present example, the first lens group G1 corresponds to the object lens group GA. The second lens group G2, the third lens group G3, and the fourth lens group G4 comprise the intermediate group GM having positive refractive power as a whole. The fifth lens group G5 corresponds to the first succeeding lens group GR1 being part of the rear group GR. The sixth lens group G6 corresponds to the second succeeding lens group GR2 being part of the rear group GR. The seventh lens group G7 corresponds to the third succeeding lens group GR3 being part of the rear group GR. Upon focusing on a short-distance object from an object at infinity, the first succeeding lens group GR1 (the fifth lens group G5) moves on the optical axis toward the image side, and the second succeeding lens group GR2 (the sixth lens group G6) moves on the optical axis toward the object side.

Data values of the zoom optical system of the third example will be listed on Table 3 below.

TABLE 3
[General Data]
Zooming ratio = 2.691
fMw = 36.199

| | W | M | T |
|---|---|---|---|
| f | 82.400 | 115.000 | 194.000 |
| FNO | 2.910 | 2.910 | 2.910 |
| 2ω | 33.525 | 21.010 | 12.536 |
| Y | 21.600 | 21.600 | 21.600 |
| TL | 160.100 | 211.900 | 223.700 |
| Bf | 16.055 | 16.055 | 16.055 |

[Lens Data]

| Surface | | | | |
|---|---|---|---|---|
| number | R | D | nd | νd |
| 1 | 199.073 | 2.200 | 1.90366 | 31.27 |
| 2 | 126.494 | 8.129 | 1.43700 | 95.10 |
| 3 | −719.999 | 0.100 | | |
| 4 | 116.402 | 7.427 | 1.43700 | 95.10 |
| 5 | 6813.349 | (D5) | | |
| 6 | −338.526 | 1.500 | 1.49700 | 81.14 |
| 7 | 34.249 | 3.505 | 1.66382 | 27.35 |
| 8 | 56.082 | 3.516 | | |
| 9 | −106.736 | 1.500 | 1.59349 | 67.00 |
| 10 | 335.611 | (D10) | | |
| 11 | ∞ | 3.047 | | (Aperture |
| | | | | Stop) |
| 12 | 39.818 | 3.718 | 1.94595 | 17.98 |
| 13 | 78.706 | (D13) | | |
| 14 | 41.584 | 4.793 | 1.49782 | 82.57 |
| 15 | 1846.157 | 1.539 | | |
| 16 | 1852.423 | 1.471 | 1.92286 | 20.88 |
| 17 | 25.361 | 4.747 | 1.43700 | 95.10 |
| 18 | 84.999 | 0.100 | | |
| 19* | 38.841 | 3.249 | 1.59255 | 67.86 |
| 20* | 109.734 | 10.867 | | |
| 21 | 77.691 | 3.955 | 1.80611 | 40.73 |
| 22 | −82.716 | (D22) | | |
| 23 | 51.729 | 2.629 | 1.94595 | 17.98 |
| 24 | 104.337 | 1.205 | 1.78590 | 44.17 |
| 25 | 22.293 | (D25) | | |
| 26* | −58.828 | 4.495 | 1.59245 | 66.92 |
| 27* | −28.061 | (D27) | | |
| 28* | −33.565 | 1.800 | 1.48749 | 70.32 |
| 29 | ∞ | Bf | | |

[Aspherical surface data]
19th surface
κ = 0.000, A4 = 3.529E−06, A6 = 7.180E−09, A8 = 1.864E−11,
A10 = 0.000E+00, A12 = 0.000E+00
20th Surface
κ = 0.000, A4 = 1.102E−05, A6 = 8.970E−09, A8 = 1.747E−11,
A10 = 0.000E+00, A12 = 0.000E+00
26th Surface
κ = 0.000, A4 = −5.680E−07, A6 = 7.802E−09, A8 = 5.979E−12,
A10 = −4.891E−13, A12 = 1.108E−15
27th Surface
κ = 0.000, A4 = 9.289E−06, A6 = 5.070E−09, A8 = 8.783E−11,
A10 = −7.537E−13, A12 = 1.362E−15
28th Surface
κ = 0.000, A4 = 1.899E−05, A6 = 2.021E−08, A8 = 1.589E−11,
A10 = −1.257E−13, A12 = 3.238E−16

[Variable distance data]

| | | |
|---|---|---|
| W | M | T |

Upon focusing on infinity

| | | | |
|---|---|---|---|
| Focal length | 82.400 | 115.000 | 194.000 |
| Distance | ∞ | ∞ | ∞ |
| D5 | 1.933 | 55.833 | 90.777 |
| D10 | 26.678 | 24.269 | 1.502 |
| D13 | 2.794 | 3.106 | 2.766 |
| D22 | 10.272 | 6.444 | 1.500 |
| D25 | 19.265 | 26.828 | 33.592 |
| D27 | 7.054 | 3.319 | 1.500 |

Upon focusing on a short-distance object

| | | | |
|---|---|---|---|
| Zoom | 0.00796 | 0.116 | 0.1758 |
| magnification | | | |
| Distance | 840.025 | 788.167 | 776.252 |
| D5 | 1.933 | 55.833 | 90.777 |
| D10 | 26.678 | 24.269 | 1.502 |
| D13 | 2.794 | 3.106 | 2.766 |
| D22 | 12.447 | 11.588 | 15.168 |
| D25 | 14.990 | 18.456 | 15.465 |
| D27 | 9.160 | 6.549 | 5.959 |

[Lens group data]

| | First | Focal |
|---|---|---|
| Group | surface | length |
| G1 | 1 | 195.158 |
| G2 | 6 | −62.952 |
| G3 | 12 | 81.410 |
| G4 | 14 | 55.746 |
| G5 | 23 | −58.164 |
| G6 | 26 | 85.895 |
| G7 | 28 | −68.853 |

FIG. 6 (A) presents graphs showing various aberrations of the zoom optical system of the third example upon focusing on infinity in the wide-angle end state. FIG. 6 (B) presents graphs showing various aberrations of the zoom optical system of the third example upon focusing on infinity in the telephoto end state. Each of the graphs showing various aberrations demonstrates that the zoom optical system of the third example has well-corrected various aberrations throughout the wide-angle end state and the telephoto end state and excellent image formation performance.

Next, a [Conditional Expression Corresponding Value] table will be shown below. This table shows a value corresponding to each of the conditional expressions (1) to (15) for all the examples (the first to third examples) collectively.

$$Conditional expression ( 1 ) \qquad 1.05 < f 1 / TLw < 2.00$$

$$Conditional expression ( 2 ) \qquad 2. 00 < f 1 / fMw < 7.$$

$$Conditional expression ( 3 ) \qquad 1. 50 < f 1 / ( - fn 1 ) < 6.$$

$$Conditional expression ( 4 ) \qquad 0. 05 < ( - fR 3 ) / ft < 1 \text{.00}$$

$$Conditional expression ( 5 ) \qquad 0. 00 < ( - fR 3 ) / fw < 2.$$

$$\begin{matrix}Conditional expression ( 6 ) & 0.15\end{matrix} < ( TLt - TLw ) / TLw < 1.$$

$$Conditional expression ( 7 ) \qquad 1. 50 < f 1 / ( - fR 3 ) < 6.00$$

$$\begin{matrix}Conditional expression ( 8 ) & 50. < vd 3\end{matrix} < 80.$$

$$\begin{matrix}Conditional expression ( 9 ) & 1.45 < nd 3\end{matrix} < 1.58$$

$$Conditional expression ( 10 ) \qquad 1. 80 < TLw / ( - fR 3 ) < 2.70$$

$$Conditional expression ( 11 ) \qquad 0.3 < ( - fR 1 ) / fR 2 < 1.30$$

$$Conditional expression ( 12 ) \qquad 0. 70 < ( - fR 1 ) / fMw < 2.$$

$$Conditional expression ( 13 ) \qquad 1. 00 < fR 2 / fMw < 3.00$$

$$Conditional expression ( 14 ) \qquad 1. 00 < ( - fR 3 ) / fMw < 3.50$$

$$Conditional expression ( 15 ) \qquad 0. 10 < Bft / ft < 0.80$$

[Conditional Expression Corresponding Value] (First to Third example)

| Conditional | First | Second | Third |
|---|---|---|---|
| Expression | example | example | example |
| (1) | 1.3795 | 1.2152 | 1.2231 |
| (2) | 4.3349 | 3.8475 | 5.3924 |
| (3) | 3.0984 | 3.2841 | 3.0984 |
| (4) | 0.2933 | 0.3510 | 0.3552 |
| (5) | 0.6905 | 0.8265 | 0.9556 |
| (6) | 0.5774 | 0.5803 | 0.3985 |
| (7) | 3.4306 | 2.5125 | 2.8331 |
| (8) | 1.4875 | 1.4875 | 1.4875 |
| (9) | 70.32 | 70.32 | 70.32 |
| (10) | 2.4868 | 2.0675 | 2.3164 |
| (11) | 0.8148 | 0.7881 | 0.6772 |
| (12) | 1.2093 | 1.1707 | 1.6068 |
| (13) | 1.4842 | 1.4854 | 2.3729 |
| (14) | 1.2627 | 1.5323 | 1.9020 |
| (15) | 0.3564 | 0.3953 | 0.4437 |

Each example described above allows for realizing a zoom optical system that is small yet with bright and good optical performance.

Each example described above presents a concrete example of the invention, and the invention is not limited to those examples.

The following items may be appropriately adopted as long as they do not compromise the optical performance of the zoom optical system of each embodiment.

While five-group, six-group, and seven-group configurations have been shown as examples of the zoom optical system of each embodiment, the invention is not limited to these, and the zoom optical system with other group configurations (e.g., eight-group, nine-group, and ten-group) can be constructed. For example, there may be a configuration in which a lens or a lens group is added closest to the object side or image side of the zoom optical system of each embodiment. For another example, there may be a configuration in which a lens or a lens group is added at the object-side end or image-side end of the intermediate group in the zoom optical system of each embodiment. Note that a lens group refers to a part having at least one lens and separated by an air distance that varies upon zooming.

In the zoom optical system of each embodiment, not only the first and second succeeding lens groups (i.e., the fourth and fifth lens groups, the third and fourth lens groups, or the fifth and sixth lens groups) but also one or more lens groups or partial lens groups may be moved in the direction of the optical axis to be one or more focusing lens groups to focus on a short-distance object from an object at infinity. The one or more focusing lens groups can be applied to auto focusing, and are also suitable for motor drive (using an ultrasonic motor or the like) for auto focusing.

A lens group or a partial lens group may be moved in such a way as to have a component perpendicular to the optical axis or be rotated (swung) within a plane including the optical axis, so as to be a vibration-proof lens group that corrects image blur caused by camera shake.

Each lens surface may be formed as a spherical surface, a plane surface, or an aspherical surface. A spherical or plane lens surface is preferable because it facilitates lens processing and assembly alignment and can prevent deterioration in optical performance due to errors in processing and assembly alignment. It is also preferable because deterioration in rendering performance is small even when the image plane is misaligned.

If any lens surface is aspherical, the aspherical surface may be any of an aspherical surface formed by a grinding process, a glass-molded aspherical surface formed by shaping glass into an aspherical shape using a mold, and a composite-type aspherical surface formed by molding a resin over a glass surface into an aspherical shape. Each lens surface may also be a diffractive surface, and the lens may be a graded index lens (a GRIN lens) or a plastic lens.

While the aperture stop is preferably disposed within the intermediate group (i.e., between the second and third lens groups, or within the second lens group), its function may be substituted by a lens frame without providing a member as the aperture stop.

An anti-reflection coating having high transmittance over a broad wavelength range may be applied to each lens surface in order to reduce ghost and flare and achieve high-contrast optical performance.

### EXPLANATION OF NUMERALS AND CHARACTERS

G1: First lens group
G2: Second lens group
G3: Third lens group
G4: Fourth lens group
G5: Fifth lens group
G6: Sixth lens group
G7: Seventh lens group
I: Image plane
S: Aperture stop

1. A zoom optical system consisting of, in order from an object side on an optical axis:
an object lens group having positive refractive power;
an intermediate group having positive refractive power; and
a rear group,
wherein the intermediate group comprises at least one lens group,
wherein the rear group comprises, in order from the object side on the optical axis: a first succeeding lens group having negative refractive power; a second succeeding lens group having positive refractive power; and a third succeeding lens group having negative refractive power, wherein a distance between each adjacent lens group varies upon zooming,
wherein the second succeeding lens group moves on the optical axis upon focusing, and
wherein a following conditional expression is satisfied:
$$1. 5 < f 1 / TLw < 2.$$
where f1 is a focal length of the object lens group, and TLw is an entire length of the zoom optical system in a wide-angle end state.

2. A zoom optical system consisting of, in order from an object side on an optical axis:
an object lens group having positive refractive power;
an intermediate group having positive refractive power; and
a rear group,
wherein the intermediate group comprises at least one lens group,
wherein the rear group comprises, in order from the object side on the optical axis: a first succeeding lens group having negative refractive power; a second succeeding lens group having positive refractive power; and a third succeeding lens group having negative refractive power,
wherein a distance between each adjacent lens group varies and at least one lens group in the intermediate group is fixed relative to an image plane upon zooming, and
wherein a following conditional expression is satisfied:
$$2. < f 1 / fMw < 7. .$$
where f1 is a focal length of the object lens group, and fMw is a combined focal length of the intermediate group in a wide-angle end state.

3. The zoom optical system according to claim 2, wherein the second succeeding lens group moves on the optical axis upon focusing.

4. The zoom optical system according to claim 1, wherein a following conditional expression is satisfied:
$$1.5 < f 1 / ( - fn 1 ) < 6.$$
where fn1 is a focal length of a lens group disposed closest to the object side among lens groups in the zoom optical system that have negative refractive power.

5. The zoom optical system according to claim 1, wherein a following conditional expression is satisfied:
$$0.05 < ( - fR 3 ) / ft < 1.$$
where fR3 is a focal length of the third succeeding lens group, and ft is a focal length of the zoom optical system in a telephoto end state.

6. The zoom optical system according to claim 1, wherein a following conditional expression is satisfied:
$$0. < ( - fR 3 ) / fw < 2.00$$
where fR3 is a focal length of the third succeeding lens group, and fw is a focal length of the zoom optical system in the wide-angle end state.

7. The zoom optical system according to claim 1, wherein a following conditional expression is satisfied:
$$0. 15 < ( TLt - TLw ) / TLw < 1.$$
where TLt is an entire length of the zoom optical system in a telephoto end state, and TLw is an entire length of the zoom optical system in the wide-angle end state.

8. The zoom optical system according to claim 1, wherein a following conditional expression is satisfied:
$$1.5 < f 1 / ( - fR 3 ) < 6.$$
where fR3 is a focal length of the third succeeding lens group.

9. The zoom optical system according to claim 1, wherein the third succeeding lens group comprises a lens satisfying following conditional expressions:
$$50. < vd 3 < 80.$$
$$1.45 < nd 3 < 1.58$$
where νd3 is an Abbe number of the lens in the third succeeding lens group, and nd3 is a refractive index of the lens in the third succeeding lens group at the d-line.

10. The zoom optical system according to claim 1, wherein a following conditional expression is satisfied:
$$1.8 < TLw / ( - fR 3 ) < 2.7$$
where TLw is an entire length of the zoom optical system in the wide-angle end state, and fR3 is a focal length of the third succeeding lens group.

11. The zoom optical system according to claim 1, wherein a following conditional expression is satisfied:
$$0.3 < ( - fR 1 ) / fR 2 < 1.3$$
where fR1 is a focal length of the first succeeding lens group, and fR2 is a focal length of the second succeeding lens group.

12. The zoom optical system according to claim 1, wherein a following conditional expression is satisfied:
$$0.7 < ( - fR 1 ) / fMw < 2.$$
where fR1 is a focal length of the first succeeding lens group, and fMw is a combined focal length of the intermediate group in the wide-angle end state.

13. The zoom optical system according to claim 1, wherein a following conditional expression is satisfied:
$$1. 00 < fR 2 / fMw < 3.00$$
where fR2 is a focal length of the second succeeding lens group, and fMw is a combined focal length of the intermediate group in the wide-angle end state.

14. The zoom optical system according to claim 1, wherein a following conditional expression is satisfied:
$$1. < ( - fR 3 ) / fMw < 3.50$$
where fR3 is a focal length of the third succeeding lens group, and fMw is a combined focal length of the intermediate group in the wide-angle end state.

15. The zoom optical system according to claim 1, wherein a following conditional expression is satisfied:
$$0.1 < Bft / ft < 0.8$$
where Bft is a back focus of the zoom optical system in a telephoto end state, and ft is a focal length of the zoom optical system in the telephoto end state.

16. The zoom optical system according to claim 1, wherein the third succeeding lens group is fixed relative to an image plane upon zooming.

17. The zoom optical system according to claim 1, wherein the first succeeding lens group moves on the optical axis upon focusing.

18. An optical apparatus comprising the zoom optical system according to claim 1.

19. A method for manufacturing a zoom optical system consisting of, in order from an object side on an optical axis: an object lens group having positive refractive power; an intermediate group having positive refractive power; and a rear group, the method comprising steps of disposing each lens in a lens barrel in such a way that
the intermediate group comprises at least one lens group,
the rear group comprises, in order from the object side on the optical axis: a first succeeding lens group having negative refractive power; a second succeeding lens group having positive refractive power; and a third succeeding lens group having negative refractive power,
a distance between each adjacent lens group varies upon zooming,
the second succeeding lens group moves on the optical axis upon focusing, and
a following conditional expression is satisfied:
$$1. 5 < f 1 / TLw < 2.$$
where f1 is a focal length of the object lens group, and TLw is an entire length of the zoom optical system in a wide-angle end state.

20. A method for manufacturing a zoom optical system consisting of, in order from an object side on an optical axis: an object lens group having positive refractive power; an intermediate group having positive refractive power; and a rear group, the method comprising steps of disposing each lens in a lens barrel in such a way that
the intermediate group comprises at least one lens group,
the rear group comprises, in order from the object side on the optical axis: a first succeeding lens group having negative refractive power; a second succeeding lens group having positive refractive power; and a third succeeding lens group having negative refractive power,
a distance between each adjacent lens group varies and at least one lens group in the intermediate group is fixed relative to an image plane upon zooming, and
a following conditional expression is satisfied:
$$2. < f 1 / fMw < 7.$$
where f1 is a focal length of the object lens group, and fMw is a combined focal length of the intermediate group in a wide-angle end state.
